(19) United States
(12) Patent Application Publication
(10) Pub. No.: US 2026/0295758 A1
(43) Pub. Date: Oct. 1, 2026

(54) STRAIGHTNESS ERROR COMPENSATION METHOD AND STRAIGHTNESS ERROR COMPENSATION APPARATUS FOR MACHINE TOOL

(71) Applicant: OKUMA CORPORATION, Niwa-Gun (JP)

(72) Inventor: Tetsuya MATSUSHITA, Niwa-Gun (JP)

(73) Assignee: OKUMA CORPORATION, Niwa-Gun (JP)

(21) Appl. No.: 19/564,423

(22) Filed: Mar. 12, 2026

(30) Foreign Application Priority Data
Mar. 27, 2025 (JP) 2025-054227

(51) Int. Cl. B23Q 17/20; B23Q 15/24

(52) U.S. Cl. CPC B23Q 17/20; B23Q 15/24

(57) ABSTRACT

A straightness error compensation method for a machine tool with two main spindle head drive axes includes: calculating a table upper surface straightness curve based on a straightness curve of an upper surface of a bed and a command position of a table drive axis; calculating an inclination estimation value of a workpiece based on fixed position information of the workpiece with respect to a reference position of a table and the calculated table upper surface straightness curve; calculating a straightness error estimation value of the table drive axis at a position of a main spindle head based on the command position of the table drive axis, the calculated table upper surface straightness curve, and the calculated inclination estimation value of the workpiece; and controlling to compensate at least one of the main spindle head drive axes using the calculated straightness error estimation value as a compensation amount.

### CROSS REFERENCE TO RELATED APPLICATION

This application claims the benefit of Japanese Patent Application Number 2025-054227 on Mar. 27, 2025, the entirety of which is incorporated by reference.

### FIELD OF THE INVENTION

The present disclosure relates to a compensation method and a compensation device for a straightness error of a machine tool.

### BACKGROUND OF THE INVENTION

FIG. 1 is a schematic diagram of a common double column machining center. In FIG. 1, an X-axis direction indicates a front-rear direction, a Y-axis direction indicates a right-left direction, and a Z-axis direction indicates an up-down direction of a double column machining center M.

The double column machining center M as a machine tool is a three-axis machining center that includes a bed 1, a table 2, a column 4, and a main spindle head 3.

The bed 1 is, for example, installed and fixed on a floor. The bed 1 has an upper surface on which an X-axis guide 2a is formed as illustrated in FIG. 1. On the X-axis guide 2a, the table 2 on which a workpiece, which is not illustrated, is fixable is provided movably in the X-axis direction. Specifically, the table 2 is movable with respect to the bed 1 with one translational degree of freedom by the X-axis guide 2a in a linear drive axis.

The column 4 is disposed upright on a rear portion side of the bed 1. The column has a front surface on which a Y-axis guide 4a is formed. The Y-axis guide 4a has a saddle 5 provided movably in the Y-axis direction. Furthermore, the saddle 5 has a front surface on which a Z-axis guide 5a is provided. The Z-axis guide 5a has a main spindle ram 6 provided movably in the Z-axis direction. A predetermined tool T is mountable onto the main spindle head 3, and the main spindle head 3 is provided at a lower end portion of the main spindle ram 6. Accordingly, the main spindle head 3 is movable in the Y-axis direction and the Z-axis direction. Specifically, the main spindle head 3 is movable with respect to the bed 1 with two translational degrees of freedom by the Y-axis guide and the Z-axis guide in linear drive axes mutually orthogonal and each perpendicular to the X-axis. Accordingly, in combination with the movement of the table 2, the main spindle head 3 is movable with respect to the bed 1 with three translational degrees of freedom. Each of the axis guides 2a, 4a, 5a is driven by a servomotor, which is not illustrated, controlled by a numerical control unit, which is not illustrated, and allows the workpiece to be machined into any shape.

A straightness error of the linear drive axis is one of the main causes of a motion error of the double column machining center M as described above. For example, the straightness error of the X-axis appears as an error in the Y-axis direction or the Z-axis direction that changes corresponding to a position on the X-axis. When the straightness error of the X-axis is large, a machining defect possibly occurs due to the straightness error when the table 2 is moved during the machining of a workpiece.

As a countermeasure for the straightness error of the linear drive axis, for example, JP1983-114845A discloses a compensation method for a straightness error that uses a compensation amount of a position in a perpendicular direction with respect to a position of one linear drive axis, and controls to compensate another linear drive axis corresponding to the position of the linear drive axis.

With the method of JP1983-114845A, for example, the straightness in a Y-direction of a Z-axis is compensated by operating a Y-axis by a compensation amount corresponding to an operation of the Z-axis.

Here, using a Z-axis direction straightness error of the X-axis guide 2a as an example, the straightness error of the X-axis of the double column machining center M will be described in detail. FIG. 2 is a schematic diagram of the measurement of the Z-axis direction straightness error of the X-axis guide 2a of the double column machining center in FIG. 1 and a graph showing an exemplary measurement result.

To measure the Z-axis direction straightness error of the X-axis guide 2a of the double column machining center M, a displacement sensor 7 is attached to the main spindle head 3 as illustrated in FIG. 2. Furthermore, a straightedge ruler 8 is installed at a measurement point a on the table 2, and, for example, an upper surface position of the straightedge ruler 8 is measured while the table 2 is driven. Subsequently, the straightedge ruler 8 is installed at a measurement point b with at least a different X-axis position, and similarly to the measurement at the measurement point a, the upper surface position of the straightedge ruler 8 is measured. From the measurement result, respective Z-direction straightness errors of the X-axis at the measurement points a, b are calculated. For example, the measurement result at the measurement point a is a straightness error profile 9a, and the measurement result at the measurement point b is a straightness error profile 9b.

In the double column machining center M, the Z-axis direction straightness error of the X-axis occurs due to the Z-axis direction straightness of the X-axis guide 2a on the upper surface of the bed 1. In other words, the Z-direction straightness error of the X-axis in the double column machining center M depends on a position of a measurement point with respect to the bed 1, not a position of a measurement point on the table 2. As described above, the measurement point a and the measurement point b have different positions on the table 2, whereas the straightness error profile 9a and the straightness error profile 9b obtained with the measurement exhibit approximately the same shapes as illustrated in FIG. 2. Thus, the Z-axis direction straightness error of the X-axis guide in the double column machining center M appears as a similar measurement result even when the position of the X-axis is changed on the table 2, such as the measurement point a or the measurement point b. This is because the measurement is taken immediately below the main spindle head 3 even though the measurement points a, b are set at different positions on the table 2, and therefore, the X-axis direction positions of the measurement points a, b with respect to the bed 1 are the same at the time of the measurement.

As described above, in the straightness compensation method disclosed in JP1983-114845A, the straightness is compensated using the compensation amount corresponding to the position of the linear drive axis. Therefore, when a position of a workpiece on the table is changed, the position of the linear drive axis needs to be changed corresponding to the position change. Since the compensation amount corresponds to the position of the linear drive axis, the compensation amount changes before and after the position change of the workpiece. When the method disclosed in JP1983-114845A is applied to the above-described double column machining center M, the change of the linear drive axis is equivalent to the position change of the X-axis. The position change of the X-axis is equivalent to the position change of the table 2 on the bed 1. That is, the compensation amount is different before and after the position change of the table 2. However, in addition to the fact that the shape of the X-axis guide 2a appearing as the straightness error of the bed causes the straightness error of the upper surface of the table, the effect of the straightness due to the bed is the same irrespective of the position of the workpiece on the table as described above. Accordingly, in some cases, the straightness depending on the position on the bed may fail to be appropriately compensated.

Therefore, one of its objectives of the present disclosure is to provide a straightness error compensation method and a straightness error compensation apparatus for a machine tool capable of appropriately compensating a straightness error caused by a straightness of an upper surface of a bed in the machine tool having a table linear drive axis.

### SUMMARY OF THE INVENTION

In order to solve the above-described issue, a first configuration of the disclosure is a straightness error compensation method for a machine tool. The machine tool includes a bed, a table on which a workpiece is fixable, a main spindle head capable of rotating a mounted tool, a table drive axis that allows for a linear motion of the table with respect to the bed, and two main spindle head drive axes that allow for rectilinear motions of the main spindle head in directions each perpendicular to the table drive axis with respect to the bed. The straightness error compensation method includes: calculating a table upper surface straightness curve based on a straightness curve of an upper surface of the bed and a command position of the table drive axis; calculating an inclination estimation value of the workpiece based on fixed position information of the workpiece with respect to a reference position of the table and the calculated table upper surface straightness curve; calculating a straightness error estimation value of the table drive axis at a position of the main spindle head based on the command position of the table drive axis, the calculated table upper surface straightness curve, and the calculated inclination estimation value of the workpiece; and controlling to compensate at least one of the main spindle head drive axes using the calculated straightness error estimation value as a compensation amount.

In another aspect of the first configuration of the disclosure is, which is in the above-described configuration, the workpiece is fixed at a plurality of points on the table. In the calculation of the inclination estimation value, a difference value between values of a plurality of the table upper surface straightness curves corresponding to the fixed position information of a respective plurality of the fixed positions is used.

In order to solve the above-described issue, a second configuration of the disclosure is a straightness error compensation apparatus for a machine tool. The machine tool includes a bed, a table on which a workpiece is fixable, a main spindle head capable of rotating a mounted tool, a table drive axis that allows for a linear motion of the table with respect to the bed, and two main spindle head drive axes that allow for rectilinear motions of the main spindle head in directions each perpendicular to the table drive axis with respect to the bed. The straightness error compensation apparatus includes a bed curve storage unit, a fixed position information storage unit, a table curve calculator, a workpiece inclination calculator, a straightness error calculator, and a compensation control unit. The bed curve storage unit stores a straightness curve of an upper surface of the bed. The fixed position information storage unit stores fixed position information of the workpiece with respect to a reference position of the table. The table curve calculator calculates a table upper surface straightness curve based on a straightness curve of an upper surface of the bed stored in the bed curve storage unit and a command position of the table drive axis. The workpiece inclination calculator calculates an inclination estimation value of the workpiece based on the fixed position information stored in the fixed position information storage unit and the calculated table upper surface straightness curve. The straightness error calculator calculates a straightness error estimation value of the table drive axis at a position of the main spindle head based on the command position of the table drive axis, the calculated table upper surface straightness curve, and the calculated inclination estimation value of the workpiece. The compensation control unit controls to compensate at least one of the main spindle head drive axes using the calculated straightness error estimation value as a compensation amount.

In another aspect of the second configuration of the disclosure is, which is in the above-described configuration, the workpiece is fixed at a plurality of points on the table. In the workpiece inclination calculator, the inclination estimation value of the workpiece is calculated using a difference value between a plurality of values of the table upper surface straightness curves corresponding to a respective plurality of the fixed positions of the fixed position information.

With the present disclosure, the straightness error compensation method and the straightness error compensation apparatus for the machine tool calculate the straightness error estimation value based on the table upper surface straightness curve taking the bed upper surface straightness curve into account, and the workpiece inclination estimation value, and execute the compensation based on the estimation value. Therefore, the straightness error in the table linear drive axis caused by the straightness of the upper surface of the bed, which has failed to be managed by the conventional straightness compensation that compensates with the compensation amount corresponding to the position of the linear drive axis, becomes appropriately compensatable. Specifically, the straightness compensation considering that the workpiece inclines corresponding to the fixed position, the table fails to move straight, and the like is possible.

For example, by applying the straightness error compensation method and the straightness error compensation apparatus according to the present disclosure, high machining accuracy can be maintained even in a place prone to have a straightness error of the table linear drive axis due to an occurrence of a deformation of a floor surface over time on which the machine tool is installed, which in turn causes the bed to deform.

### BRIEF DESCRIPTION OF THE DRAWINGS

FIG. 1 is an explanatory view illustrating a common double column machining center.

FIG. 2 is an explanatory view illustrating straightness measurement of a double column machining center.

FIG. 3 is an explanatory view illustrating a configuration of a straightness error compensation apparatus according to the present disclosure.

FIG. 4 is a schematic diagram of a positional relationship between each of the coordinate systems.

FIG. 5 is a flowchart relating to a straightness error compensation method according to the present disclosure.

FIG. 6 is a schematic diagram of each of the coordinate systems and each of the straightness curves.

FIG. 7 is a schematic diagram of each coordinate system, a table upper surface straightness curve, and a workpiece inclination error.

### DETAILED DESCRIPTION OF THE INVENTION

The following describes an embodiment of the present disclosure based on the drawings.

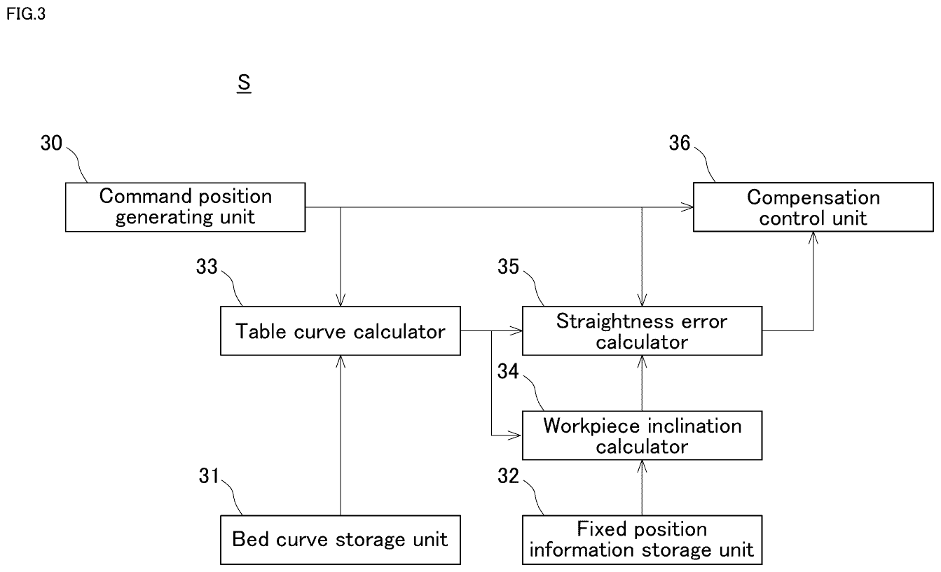

FIG. 3 is an explanatory view illustrating a configuration of a straightness error compensation apparatus S.

The straightness error compensation apparatus S includes a command position generating unit 30, a bed curve storage unit 31, a fixed position information storage unit 32, a table curve calculator 33, a workpiece inclination calculator 34, a straightness error calculator 35, and a compensation control unit 36.

In the present disclosure, the straightness error compensation apparatus S is assumed to be built as a part of the functions of a numerical control unit that is not illustrated and plays a role in controlling a double column machining center M. The numerical control unit includes a CPU and a memory connected to the CPU, and achieves operations of, for example, various kinds of operational controls, information storage, and computing by using the CPU and the memory. However, the straightness error compensation apparatus S may be provided as an independent piece of equipment separate from the numerical control unit, or may be provided as a part of functions of another calculator.

The command position generating unit 30 generates command positions of respective axes.

The bed curve storage unit 31 stores a bed upper surface straightness curve fb(x) representing the shape of a bed guide surface.

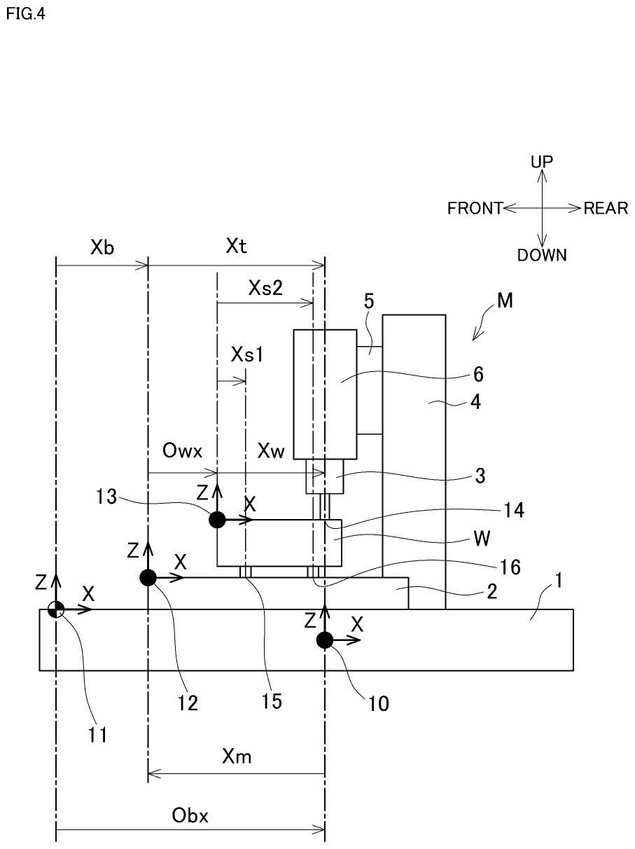

The fixed position information storage unit 32 stores fixed position information as information of a fixed position of a workpiece W with respect to the table 2. Here, as illustrated in FIG. 4, when the workpiece W is fixed at two positions, the respective pieces of position information of a fixed position 15 and a fixed position 16 are stored.

The table curve calculator 33 calculates a table upper surface straightness curve ft(x) from the bed upper surface straightness curve fb(x) stored in the bed curve storage unit 31 and the command position of the X-axis.

The workpiece inclination calculator 34 calculates an inclination estimation value θt of the workpiece W from the fixed position information stored in the fixed position information storage unit 32 and the table upper surface straightness curve ft(x).

The straightness error calculator 35 calculates a straightness error estimation value dZ at a position immediately below the main spindle head 3 as a machining point of the workpiece W from the table upper surface straightness curve ft(x), the command position of the X-axis, and the inclination estimation value θt of the workpiece W.

The compensation control unit 36 uses the straightness error estimation value dZ as a compensation value, and controls to compensate the Z-axis corresponding to the command position of the X-axis.

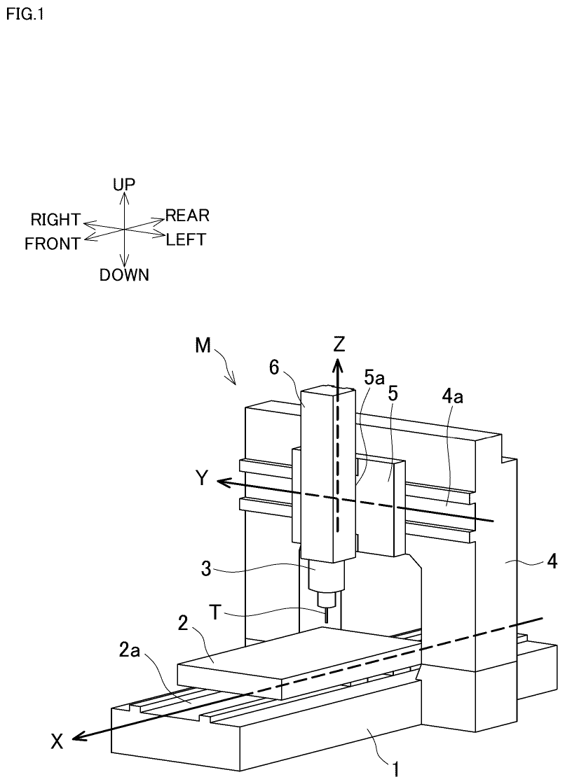

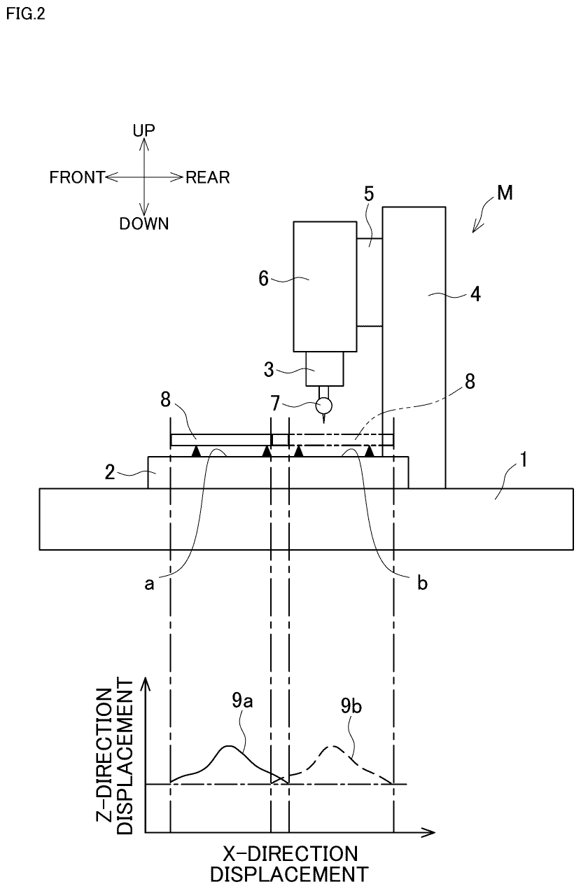

FIG. 4 illustrates a positional relationship between each of the coordinate systems when the workpiece W is fixed and machined on the table 2 of the double column machining center M in FIG. 1. Explanations of similar configurations relating to the above-described FIG. 1 and FIG. 2 are omitted.

A machine coordinate system 10 is on the bed 1 as illustrated in FIG. 4. Also, it is assumed that an X-direction position of the origin of the machine coordinate system 10 is identical to a machining point 14. The machining point 14 is a control target point, and is a compensation target position of the straightness error.

A bed coordinate system 11 is on the upper surface of the bed 1. In the present disclosure, the origin of the bed coordinate system 11 is assumed to be at the position of −Obx in the X-direction in the machine coordinate system 10.

A table coordinate system 12 is on an upper surface of the table 2. In the present disclosure, it is assumed that the table coordinate system 12 has moved by −Xm from the machine coordinate system 10 in association with the movement of the table 2 at an X-axis command position Xm in the machine coordinate system 10. Therefore, as illustrated in FIG. 4, the origin of the table coordinate system 12 is at a position Xb moved by (Obx−Xm) in the X-direction in the bed coordinate system 11.

A workpiece coordinate system 13 is on an upper surface of the workpiece W. In the present disclosure, the workpiece coordinate system 13 is set at a coordinate position of (Owx, Owy, Owz) in the table coordinate system 12. Here, the X-axis command position in the workpiece coordinate system 13 is assumed to be Xw. Specifically, as illustrated in FIG. 4, an X-coordinate Xt of the machining point 14 in the table coordinate system 12 is said to be (Xw+Owx). As illustrated in FIG. 4, the X-coordinate Xt of the machining point 14 in the table coordinate system 12 and the X-axis command position Xm in the machine coordinate system 10 are in the relationship indicating the same positions on the X-axis.

The workpiece W is fixed at two positions of the fixed positions 15, 16 in the X-axis direction with respect to the table 2. The fixed position 15 in the workpiece coordinate system 13 has an X-coordinate value of Xs1. The fixed position 16 in the workpiece coordinate system 13 has an X-coordinate value of Xs2.

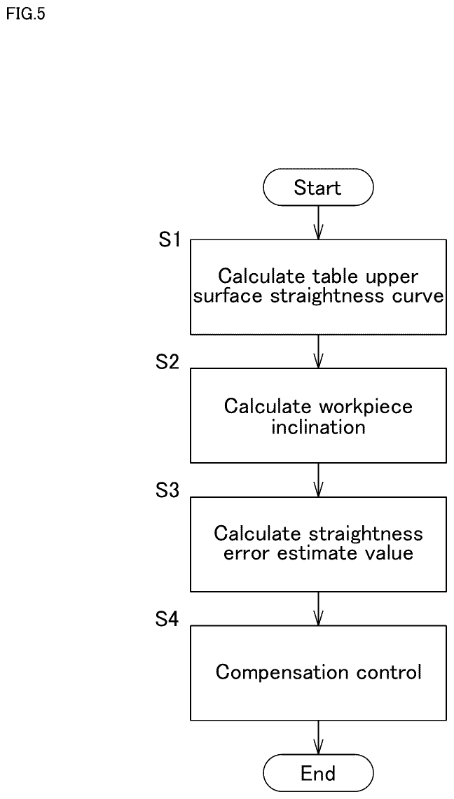

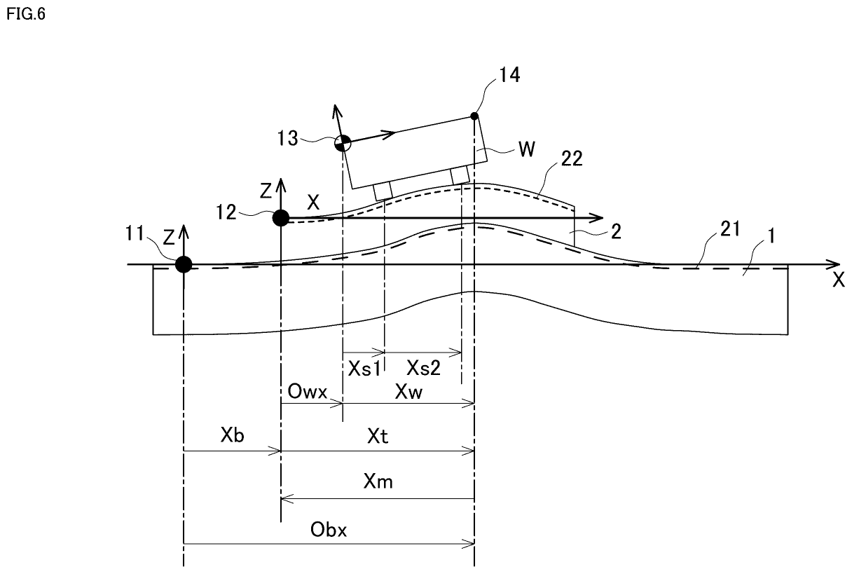

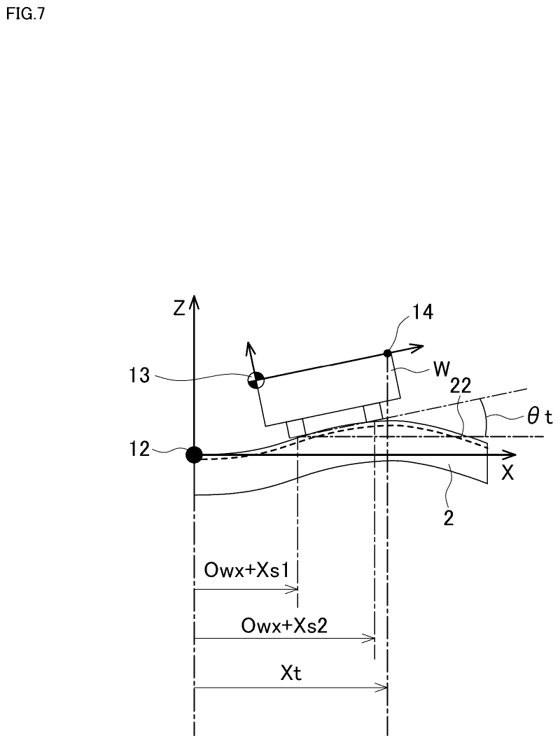

The following describes a straightness error compensation method according to the present disclosure based on the flowchart in FIG. 5, and FIG. 6 and FIG. 7 that are schematic diagrams of the calculating method. Specifically, the method of compensating the Z-axis direction straightness error of the X-axis of the double column machining center M will be described.

In Step S1, a table upper surface straightness curve 22 in the table coordinate system 12 illustrated in FIG. 6 and FIG. 7 is calculated.

First, the X-origin position Xb of the table coordinate system 12 in the bed coordinate system 11 is obtained with Formula (1) based on the X-axis command position Xw in the workpiece coordinate system 13. The position Xb is a reference position of the table 2 with respect to the bed 1 in the present disclosure.

$$Xb = Obx - Xt = Obx - Xm = Obx - ( Xw + Owx ) \qquad ( 1 )$$

Subsequently, a function representing a bed upper surface straightness curve 21 representing the shape of the X-axis guide surface of the bed 1 in the bed coordinate system 11 is denoted as the bed upper surface straightness curve fb(x). The X-origin position of the table coordinate system 12 in the bed coordinate system 11 calculated from the command position of the X-axis is denoted as Xb. The table upper surface straightness curve ft(x) as a function representing the table upper surface straightness curve 22 in the table coordinate system 12 is obtained with Formula (2).

$$ft ( x ) = G \cdot fb ( x + Xb ) \qquad ( 2 )$$

Here, the bed upper surface straightness curve fb(x) is given by a function, such as an nth-degree polynomial, line segments defined by multiple point sets, or an nth-degree interpolation curve. For example, the bed upper surface straightness curve fb(x) is obtained by directly measuring the X-axis guide on the upper surface of the bed 1 in advance.

In addition, G is a transfer function defined by the rigidity of the table 2 and the X-axis guide mechanism. When the rigidity on the table 2 side is high, the shape of the bed upper surface straightness curve fb(x) is less likely to be transferred to the table upper surface straightness curve ft(x). On the other hand, when the rigidity of the table 2 side is low, and the bed upper surface straightness curve fb(x) is directly transferred, the table upper surface straightness curve ft(x) is obtained with Formula (3). For the rigidity of the bed 1 and the table 2, for example, machine information relating to the specifications may be referred to.

$$ft ( x ) = f b ( x + X b ) \qquad ( 3 )$$

In Step S2, the inclination estimation value θt of the workpiece W illustrated in FIG. 7 is calculated. The inclination estimation value θt of the workpiece W is obtained with Formula (4) based on the table upper surface straightness curve ft(x) calculated in Step S1 and X-positions Xs1, Xs2 in the workpiece coordinate system 13 of the respective fixed positions 15 and 16 of the workpiece W.

$$θ t = \{ ft ( Owx + X s 2 ) - ft ( Owx + Xs 1 ) \} / ( Xs 2 - Xs 1 ) \qquad ( 4 )$$

For example, when the fixed position of the workpiece W is one or when an interval between the fixed positions 15 and 16 is short, the inclination estimation value θt of the workpiece W is obtained with Formula (5) based on a differential value δft/δx(x) of the table upper surface straightness curve ft(x). When the fixed position is one, the fixed position is treated as the fixed position 15. When the interval between the fixed positions 15 and 16 is short, only the fixed position 15 is taken into account.

When the inclination of the workpiece W is not taken into account, the inclination estimation value θt may be estimated to be 0 in Step S2.

$$θ t = δ ft / δ x ( O w x ) \qquad ( 5 )$$

In Step S3, the straightness error estimation value dZ in the Z-direction of the X-axis at the machining point 14 is calculated. Based on the inclination estimation value θt of the workpiece W obtained in Step S2, the table upper surface straightness curve ft(x) calculated in Step S1, and the position of the machining point 14 in the table coordinate system 12 obtained from the X-axis command position Xw in the workpiece coordinate system 13, the straightness error estimation value dZ in the Z-direction of the X-axis at the machining point 14 is obtained with Formula (6).

$$dZ = ( Xw - X s1 ) * θ t + ft ( Xs 1 ) \qquad ( 6 )$$

In Step S4, compensation control of the Z-axis is executed corresponding to the X-axis command position using the straightness error estimation value dZ obtained in Step S3 as the compensation amount of the Z-axis. The compensation control compensates the straightness error in the Z-direction of the X-axis caused by the straightness error of the upper surface of the bed 1. Accordingly, the Z-direction straightness error of the X-axis is reduced and the machining accuracy improves.

The straightness error compensation method and the straightness error compensation apparatus S for the double column machining center M configured as described above calculate the straightness error estimation value based on the table upper surface straightness curve taking the bed upper surface straightness curve into account and the workpiece inclination estimation value, and execute the compensation based on the estimation value. Accordingly, the straightness compensation is possible in consideration that the workpiece W inclines corresponding to the fixed positions 15, 16 and the table 2 fails to move straight and the like.

For example, the application of the straightness error compensation method and the straightness error compensation apparatus S according to the present disclosure allows for maintaining high machining accuracy even in a place prone to have a straightness error of the table linear drive axis due to an occurrence of a deformation of a floor surface over time on which the double column machining center M is installed, which in turn causes the bed 1 to deform.

The configurations of the straightness error compensation method and the straightness error compensation apparatus for the machine tool according to the present disclosure are not limited to the aspects of the above-described embodiment and can be appropriately changed as necessary without departing from the gist of the disclosure.

For example, while the above-described embodiment has described the calculation and the error compensation of the straightness error in the Z-direction of the X-axis, calculation and error compensation of a straightness error in the Y-direction may be executed, or both the straightness error in the Z-direction and the straightness error in the Y-direction may be targeted.

As long as the table drive axis that allows for the linear motion of the table with respect to the bed and the two main spindle head drive axes that allow for the rectilinear motions of the main spindle head in directions each perpendicular to the table drive axis with respect to the bed are included, the straightness error compensation method and the straightness error compensation apparatus according to the present disclosure may be applied to a machine tool other than the double column machining center.

The fixed positions of the workpiece are not limited to two, and may be one or may be three or more.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A straightness error compensation method for a machine tool, the machine tool including a bed, a table on which a workpiece is fixable, a main spindle head capable of rotating a mounted tool, a table drive axis that allows for a linear motion of the table with respect to the bed, and two main spindle head drive axes that allow for rectilinear motions of the main spindle head in directions each perpendicular to the table drive axis with respect to the bed, the straightness error compensation method comprising:
calculating a table upper surface straightness curve based on a straightness curve of an upper surface of the bed and a command position of the table drive axis;
calculating an inclination estimation value of the workpiece based on fixed position information of the workpiece with respect to a reference position of the table and the calculated table upper surface straightness curve;
calculating a straightness error estimation value of the table drive axis at a position of the main spindle head based on the command position of the table drive axis, the calculated table upper surface straightness curve, and the calculated inclination estimation value of the workpiece; and
controlling to compensate at least one of the main spindle head drive axes using the calculated straightness error estimation value as a compensation amount.

2. The straightness error compensation method of the machine tool according to claim 1, wherein
the workpiece is fixed at a plurality of points on the table, and
in the calculation of the inclination estimation value, a difference value between values of a plurality of the table upper surface straightness curves corresponding to the fixed position information of a respective plurality of the fixed positions is used.

3. A straightness error compensation apparatus for a machine tool, the machine tool including a bed, a table on which a workpiece is fixable, a main spindle head capable of rotating a mounted tool, a table drive axis that allows for a linear motion of the table with respect to the bed, and two main spindle head drive axes that allow for rectilinear motions of the main spindle head in directions each perpendicular to the table drive axis with respect to the bed, the straightness error compensation apparatus comprising:
a bed curve storage unit that stores a straightness curve of an upper surface of the bed;
a fixed position information storage unit that stores fixed position information of the workpiece with respect to a reference position of the table;
a table curve calculator that calculates a table upper surface straightness curve based on a straightness curve of an upper surface of the bed stored in the bed curve storage unit and a command position of the table drive axis;
a workpiece inclination calculator that calculates an inclination estimation value of the workpiece based on the fixed position information stored in the fixed position information storage unit and the calculated table upper surface straightness curve;
a straightness error calculator that calculates a straightness error estimation value of the table drive axis at a position of the main spindle head based on the command position of the table drive axis, the calculated table upper surface straightness curve, and the calculated inclination estimation value of the workpiece; and
a compensation control unit that controls to compensate at least one of the main spindle head drive axes using the calculated straightness error estimation value as a compensation amount.

4. The straightness error compensation apparatus for the machine tool according to claim 3, wherein
the workpiece is fixed at a plurality of points on the table, and
in the workpiece inclination calculator, the inclination estimation value of the workpiece is calculated using a difference value between a plurality of values of the table upper surface straightness curves corresponding to a respective plurality of the fixed positions of the fixed position information.
